(19) United States
(12) Patent Application Publication
(10) Pub. No.: US 2016/0380830 A1
(43) Pub. Date: Dec. 29, 2016

(54) METHOD AND SYSTEM FOR MANAGING MULTIPLE DEVICES WITHIN A NETWORK SYSTEM

(71) Applicant: ADVANTECH CO., LTD., TAIPEI (TW)

(72) Inventors: WEI JEN CHENG, TAIPEI CITY (TW); MENG TSE CHEN, TAICHUNG CITY (TW)

(21) Appl. No.: 14/752,002

(22) Filed: Jun. 26, 2015

(51) Int. Cl. H04L 12/24; H04L 29/08

(52) U.S. Cl. CPC H04L 41/12; H04L 67/02; H04L 41/0806

(57) ABSTRACT

The disclosure is related to a method and a system for managing multiple devices within a network system. For the purpose of configuration or firmware synchronization for the devices within a network segment, the system allows an operator to optionally select the nodes operating as different roles such as a master, synchronization-source device, and slave. A selected device being the master is embedded with a web-based management mechanism, and therefore is remotely accessible. The management program provides a management interface in response to a management link. The management interface allows the operator to instruct the master to synchronize its configuration/firmware with the other selected nodes. Alternatively, through the master, one of the nodes is selected to be the synchronization-source device, and instructed to share its configuration to the other nodes. Through this management mechanism, the multiple nodes can be synchronized as applying the configuration, or/and firmware simultaneously.

### BACKGROUND

1. Technical Field

The present invention is related to a method and a system for managing network devices; in particular to the management method and system for multiple devices within a network system including synchronization of configuration and/or firmware among the devices.

2. Description of Related Art

Within a conventional network system, especially the network system of industrial use, a network management mechanism is provided. For example, a host installed with a management tool is used to apply management/configuration to the network nodes under a specific communication protocol. The mentioned network nodes are such as network router, switch, or the computer systems and industrial instruments arranged in a plant. The network administrator may first enter the host having the management tool, and then access the information of the nodes over the network.

However, it is different to apply the configuration or modification to any node within the network system by the conventional management mechanism remotely. According to the conventional management scheme, the operator needs to manipulate the network node on site once any node is required to change the configuration or conduct firmware update within the network system. The management tool still allows the operator to conduct the configuration.

If multiple of the nodes within the network system are required to be configured or firmware updated, a simplified approach may be applied such as preparing an update file using a software program importing the file to the hardware. It may shorten the time when the update file with the new configuration or firmware is imported to the hardware requiring the update. However, the conventional scheme still requires the operator to conduct the updating on site; or one-by-one updating over the network.

Still further, the conventional technology can introduce a host to conduct the updating to the multiple devices within the same network session. But this host may be limited to a specific operating system since the host is required to install a program. The program allows the operator to synchronize configuration over other nodes. The configuration is such as network configuration, or updated firmware.

### SUMMARY

Different from the configurations applied to an environment with multiple devices in the conventional technology, the disclosure herein is related to a method and a system of management for multiple devices within a network system. The method for managing the multiple devices within a network system may be applied to the network system containing a plurality devices. The devices in the system may be embedded with a program in compliance with the management mechanism in accordance with the present invention. The system allows an operator to choose entering one of the devices in the network system. The device to be accessed acts as a master within the system. The configuration or firmware of the device to be accessed may be synchronized with other devices due to the operator's administration. Through the master, another device may be selected to act as a synchronization-source device which is controlled to synchronize its configuration or firmware with other devices.

In one embodiment of the invention, a device within the network system is embedded with a management serving program which allows the operator to manage the devices in the network system. For example, the management serving program is provided for the operator to perform sharing and synchronization of files. The management serving program may be a cross-platform program for initiating a management interface. The management serving program may be a web-based program that allows the device to act as a master. The web-based management mechanism allows the remote device provided for the operator to conduct the management not to be limited to any operating system. Under the other mode, the operator may select another device within the network system through a management interface initiated by the management serving program. The selected device may act as a synchronization-source device for applying or synchronizing its configuration or firmware to other devices.

According to one of the embodiments, in the method for managing the multiple devices within a network system, the system first accepts a management connection that links with the management serving program of the node/device. A management interface is initiated for performing a user identification procedure. The system then scans the devices within a network domain. The management interface is used to list the scanned devices within the network domain, and also the information associated with the device. The system configures the roles for the devices according to the management connection. For example, the node/device may be a master when it is required to accept the management connection. The master may synchronize its configuration or firmware with other nodes/devices. Further, through the master, another device can designate another device which acts as a synchronization-source device. As the master instructs, the configuration or firmware of the synchronization-source device is synchronized with other devices. Several roles played by the devices are provided for the system to synchronize the configuration and firmware with all or part of the devices.

In the method, the system receives a signal of designating a device embedded with the management serving program or another device to perform synchronization or sharing configuration/firmware, and another signal of the device(s) to be synchronized. When the designation is completed through the master, the configuration or firmware is applied to the device-to-be-synchronized.

For example, a device is designated to be a role of master when the device is selected through a management interface. The configuration or firmware may be synchronized with the other selected devices. Further, the device rather than the master may also be selected through the management interface to synchronize its configuration to others. The device to perform the synchronization rather than the master is such as a synchronization-source device. The configuration/firmware of the synchronization-source device may apply to other selected devices which act as slaves in the network system.

According to one embodiment of the system for managing the multiple devices within a network system, the system designates the roles of the devices according to the operator's administration such as selecting one of the devices to be accessed. For example, the device accepting the management connection acts as a master. Through the master, the other device can be selected to share its configuration or firmware to others. The selected device acts as the synchronization-source device. The other devices configured to receive the configuration or firmware by the synchronization process are slaves.

The master provides a management interface allows the operator to configure the master, or select other devices for synchronizing the configuration or firmware within a local-area network. The synchronization-source device may also perform an intermediate synchronization allowing the device to share its configuration/firmware with other devices.

The management mechanism allowing multiple devices to be synchronized is therefore provided.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram describing the relationship of the devices in the management for multiple devices within a network system;

FIG. 2 shows a schematic diagram depicting a system framework of the system for managing the multiple devices within a network system in one embodiment of the present invention;

FIG. 3 shows function blocks describing the master in the system for managing the multiple devices within a network system in one embodiment of the present invention;

FIG. 4 shows function blocks describing the synchronization-source device in the system for managing the multiple devices within a network system in one embodiment of the present invention;

FIG. 5 shows a flow chart describing the method for managing multiple devices within a network system in one embodiment of the present invention;

FIG. 6 shows a flow chart describing the method for managing multiple devices within a network system in one further embodiment of the present invention;

FIG. 7 shows a flow chart depicting steps for configuring a master in the method for managing the multiple devices within a network system in one embodiment;

FIG. 8 shows a flow chart depicting steps for configuring a synchronization-source device in the method for managing the multiple devices within a network system in one embodiment;

FIG. 9 shows a flow chart describing the process of synchronization in the method of the present invention in one embodiment;

FIG. 10 shows a schematic diagram of the management interface provided by the system in one embodiment of the present invention;

FIGS. 11A through 11C show the schematic diagram of the management interface of the system in one embodiment of the present invention;

FIG. 12 shows a schematic diagram describing the management interface of the system in one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

A network router or gateway is usually configured as a bridge for a network system to connect with an external device. The router is also in charge of transferring addresses for the network system. The system includes a plurality of various nodes. The nodes are such as the switch for the network system in a plant, the computer systems, the industrial equipment or instruments, and even the network-based terminal devices.

When the devices within the network system are required to update the firmware or all or part of the configurations, a method and a system for managing the multiple devices within a network system is provided. The related method renders a network management mechanism. The devices in the network system, such as the operator's administration, may optionally act as one master, one synchronization-source device, and one or more slaves. Every device may perform firmware synchronization or/and full or partial configuration synchronization according to its role.

There are one or more nodes/devices embedded with a management serving program. The management serving program may be a serving program rendering a web-based setting interface that allows the operator to access the system remotely or locally. The operator may also manage the devices in the network system by the management serving program. The management includes sharing and synchronization. The management serving program is such as a cross-platform program rendering a management interface, such as the program initiating the web page service. The device embedded with the management serving program is preferably with high capability of computation. The device acts as a master initiating the management interface for accepting the operator's remote access.

It is worth noting that the management mechanism disclosed in the disclosure requires every device have a built-in program for accepting the remote management, such as the synchronization of a configuration and firmware. The device having the management serving program may be either synchronized with the configuration and firmware, or acts as a master provided for the operator to conduct remote management. The web-based management interface is a solution for the operator to access the system, and is not limited to any specific operating system. In another aspect of the present invention, the operator may conduct the management by a proprietary program for a specific operating system. The embodiment may also not exclude the operator from conducting the management by a program connected with the system.

In one further aspect of the invention, the operator may firstly enter the one selected from the devices, and the selected one acts as a master. Through a management interface provided by the master, the operator may select another one device within the network domain to act as a synchronization-source device. After that, the synchronization-source device is instructed to share its configuration or firmware with other devices.

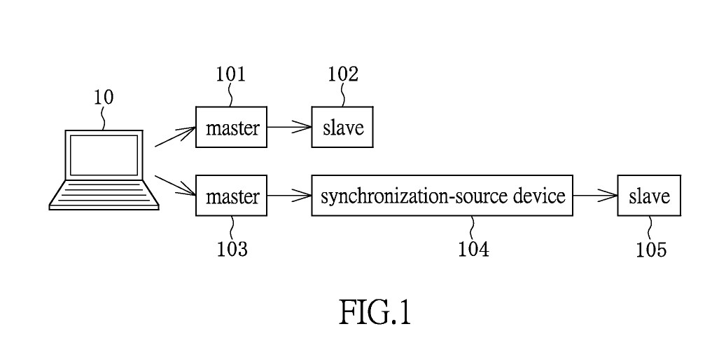

In response to a management connection, any device disposed with the management service program may act as a master within a network domain. The device acting as the master may be embedded with a management serving program. The device acting as the synchronization-source device is instructed by the master to share its configuration and/or the firmware updating. The other devices may be slaves. FIG. 1 shows a schematic diagram depicting the relationship among the roles within the system of management for multiple devices within a network system.

The system provides at least two operating modes. In one operating mode, an operator uses a computer device 10 to connect with a front-end device of the system for managing multiple devices within a network system. The network system includes a plurality of interconnected devices within a local-area network. The system instructs every device to act as its role based on the management connection. The devices may selectively play the different roles, in which any device should be in compliance with specific requirements for acting as a management device. For example, the management device may be at a suitable positon in the LAN, have eligible connections with other devices, the qualified computation capability, and preferably be embedded with a web server.

In an exemplary example, the management connection is established by the operator for connecting with a front-end device of the network domain. The front-end device is such as a device at the side closest to the external network, and the front-end device may act as a master 101 over the management connection. Via a management interface, all or part of the configuration and/or firmware may be synchronized with the back-end devices connected with the master 101. Those back-end devices may act as the slaves 102 for accepting the configuration or updated firmware. Under the current operating mode, the slaves 102 are the nodes except for the master 101.

One further operating mode is also provided. When the operator accesses a device acting as a master 103 over the management connection, a management interface is initiated by a management serving program. Through the management interface provided in the master 103, the operator may select one of the devices to share its configuration or updated firmware with other devices within the network domain. This selected device acts as a synchronization-source device 104 for performing intermediate synchronization. That means the remaining devices act as the slaves 105 accepting the configuration or/and firmware from the synchronization-source device 104.

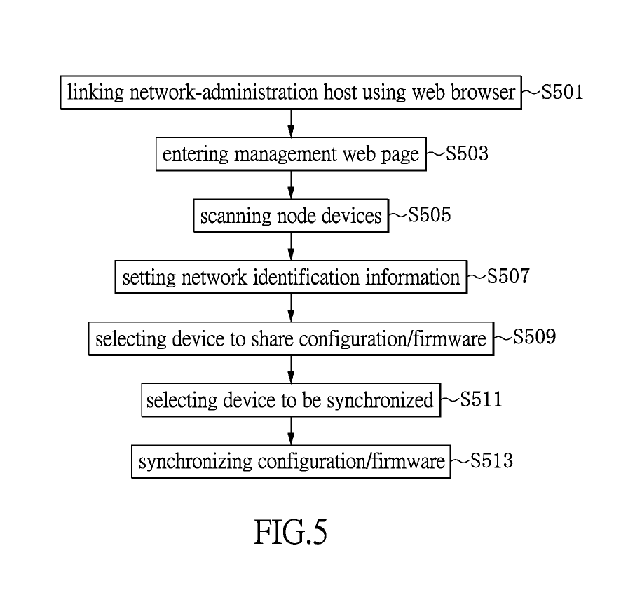

In an exemplary example, the devices within the same network domain are required to have the same network configuration so as to work normally. After that, when one or more devices are added in the network domain, the management mechanism for this system allows the operator to share the configuration in one of the devices originally in this network domain with the newly-added device(s). In the process, the operator may firstly enter one device which acts as a master, and performs synchronization for sharing its configuration with the newly-added device(s). The device acting as the master originally in the network domain is required to embed the management serving program. A related process is referred to in the flow chart in FIG. 5. Alternatively, when the operator enters the master, he may find that the configuration in the master is not suitable to the newly-added devices. Therefore, the operator may choose another device within the same network domain to conduct the synchronization with the newly-added devices. This device is different from the device designated as the master, but acts as the synchronization-source device which receives the instructions made by the master. The master instructs the operations of the synchronization of configurations or file sharing.

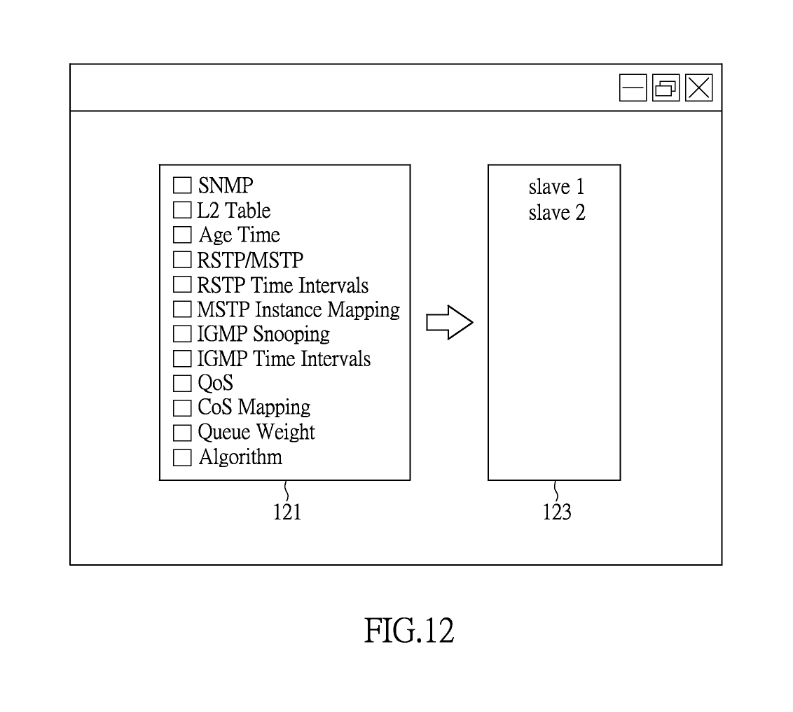

The items to be synchronized may be directed to one or more configuration, or the firmware file as described in FIG. 12.

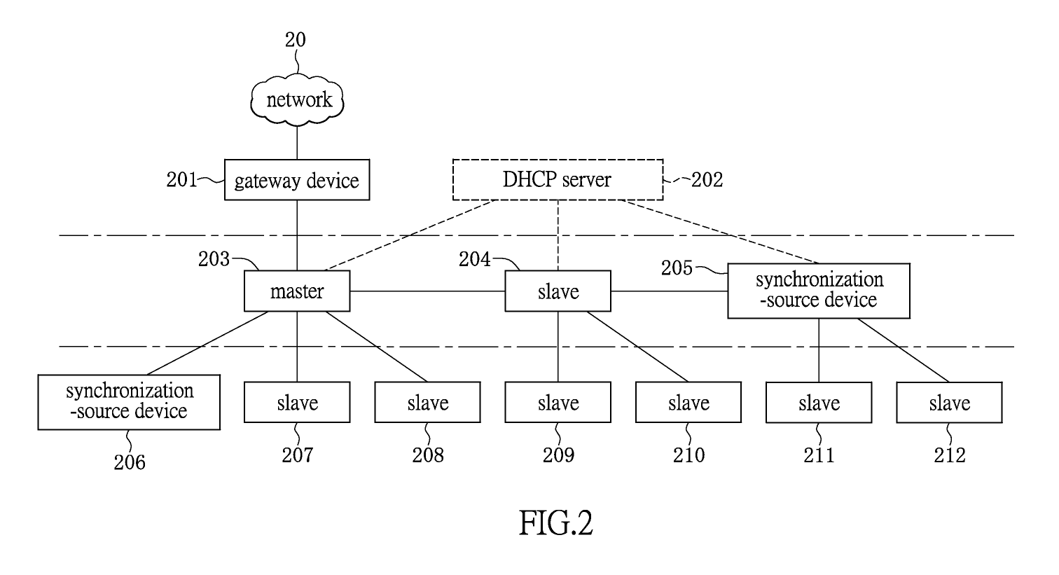

According to one of the embodiments, the system for managing the multiple devices within a network system may be referred to in the system framework depicted in FIG. 2. The system may be roughly divided into three layers. The device at higher layer denotes it is closer to the other network or the external network. The role for every device may be changed based on the instant need of the circumstance.

The present example shows the various devices within a network domain. The devices may be the industrial equipment and instruments such as the switch, server, and terminal device(s) in the network system of plant. Under the management mechanism, the device may be built in with the program for conducting setting and synchronization. One or more devices are embedded with a management serving program initiating the web-based management interface. The operator is authorized, without restriction of operating system, to operate the synchronization of the configuration or/and firmware with the devices using the web-based interfacing method.

If the device has been equipped with the functions of network management and communication, and also the management serving program, the device is qualified to be the master, synchronization-source device, or even the slave. However, if the device is just a terminal device of the whole system, it may be the slave merely for passively accepting the configuration and/or firmware since it is not equipped with functions of network management.

The current example shows a gateway device 201 disposed at the highest layer of the network system. The gateway device 201 acts as the device directing to an external network 20. This device 201 may also be a router. The network system may also require a DHCP server 202 used to automatically allocate the Internet Protocol address. The server 202 is used to manage and allocate the IP addresses within the network.

It is worth noting that the master is defined to share all or part of the configuration or the firmware with the other devices which may be the same models. Furthermore, the management mechanism may also be applied to the devices with the different models or the devices crossing over different platforms. For example, if the gateway device 201 is embedded with the management serving program for initiating the management interface, the gateway device 201 acts as a master which is able to process the remote connection. The gateway device 201 can therefore share its configuration/firmware selectively crossing platforms and equipment models. Thus the remaining devices such as the devices 203-212 act as the slaves.

According to the management mechanism of the disclosure, the devices in the system embodying the management mechanism operate under the above-mentioned roles. Based on the management connection, the devices at the higher layer with or without a network section may act as a master 203. The master 203 accepts the management connection initiating a management interface. The master 203 is also used to initialize its configuration. The configuration/firmware is such as a network function setting, including network configuration, and/or a device function setting, and/or firmware. The master 203 is able to share its configuration/firmware. The master 203 is connected with the devices within a network system. The configuration, and/or including the firmware file, of the master 203 is synchronized with other connected devices. The devices 204-212 operate as the slave to receive the configuration or firmware.

In another aspect of the management mechanism, the management interface made by the device acting as the master 203 allows the operator to select another device, acting as the shown synchronization-source device 205, or as the synchronization-source device 206 at another tier. The synchronization-source device 205 or 206 shares its configuration or firmware to other devices. The devices accepting the configuration/firmware are different from the device sharing the configuration/firmware. The other devices accepting the configuration/firmware are such as the devices 204, 206-212.

According to the embodiment of the synchronization-source device (205) sharing its own network function setting, device function setting, and/or the updating firmware, the master (203) issues a synchronization instruction under an operating mode, the synchronization-source device then delivers the configuration/firmware, in a form of a file, to the slaves (204, 206-212). Another mechanism for delivering the file is that the synchronization-source device firstly transmits its configuration/firmware to the master in a form of a file as the master issues instruction. Then the master delivers the configuration/firmware to the other devices acting as slaves to process the configuration/firmware.

The master 203 allows the operator to select one device as the synchronization-source device (205 or 206) in the network system to perform intermediate synchronization. It is noted that the synchronization-source device 205 or 206 may be disposed at the high or low tier of the network system. The synchronization-source device 205 or 206 is designated by the operator through the master 203 for sharing the configuration/firmware, including the network function setting, the device function setting, or updating firmware. In an exemplary example, the management interface is provided for the operator to make a selection from the one or more devices in the network system. The configuration/firmware of the synchronization-source device 205 or 206 is then synchronized with the other nodes, the slaves.

Other than the master 203 and the synchronization-source device 205 or 206, the remaining devices act as slaves for accepting the configuration/firmware from the master 203, or the designated synchronization-source device 205 or 206. In the diagram, the devices labeled with 204, 207, 208, 209, 210, 211, and 212 are not possibly the device for receiving the remote access, but are for accepting the configuration/firmware such as the network configuration or firmware file delivered from the master 203 or the synchronization-source device (205 or 206).

According to one aspect of the system for managing the multiple devices within a network system, the system allows the operator to optically select one node to be the master (203), or to be the synchronization-source device (205 or 206). The remaining nodes are as the slaves (204, 207, 208, 209, 210, 211, 212).

Over the network, the operator enters the network domain and accesses a device as the master (203) via a router or a gateway of the network system. The master 203 is preferred to have a management mechanism activating a web server to initiate the management web page. The master 203 initiates a management interface according to an access signal. Firstly, a scanning procedure is performed to scan the devices within the network domain. The scanning result is listed on the management interface. The operator sets the settings manually or automatically, such as setting the IP address corresponding to the MAC address. The setting also includes the identification data, the number, network address, MAC address, etc., of the master or synchronization-source device to be selected.

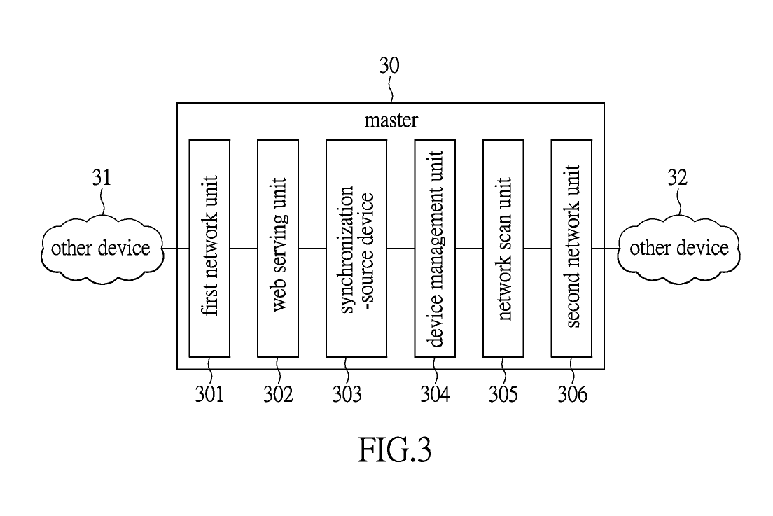

The main circuits of the master in the system for managing multiple devices within a network system are schematically described in FIG. 3. The main circuit modules embodying the management device are shown in the diagram. The master 30 includes at least two network connection interfaces, such as a first network unit 301 for connecting with external network, and a second network unit 306 for connecting with another device 32 or other network.

The master 30 has hardware circuitry, or software modules. For example, a network unit 301 is provided for the master to connect with the device 31. The first network unit 301 includes a circuit unit in compliance with the communication protocol of Ethernet, and the related program. The first network unit 301 renders a management connection allowing the operator to enter and sets up the network connection interface of the system. The master 30 may also connect with the external network such as Internet, or other network via a gateway device. The gateway device may be a router or a gateway.

The device acting as the master 30 is embedded with a web serving unit 302 which is preferably a software-based management interface allowing remote setting. The web serving unit 302 includes a serving program for managing external connection requests. When the web serving unit 302 receives a connection request, a management serving program is called for initiating a management interface provided for other devices 31 to access. In one embodiment, the management serving program may act as a daemon such as a web server. The management serving program renders a web-based management interface allowing the operator to establish a remote connection to the web server using a web browser. A web page is initiated for the further configuration.

The master 30 has a configuration-synchronization unit 303 such as a software-implemented setting module. The operator may enter the master 30 via a specific channel over a network. The management interface is provided for the operator to perform administration and setting. The setting is such as the network configuration for the network system and/or updating firmware for the specified device. The configuration/firmware may be applied to other device(s). Alternatively, one device within the network domain is designated to share its configuration/firmware with other device(s). The configuration/firmware is such as the network configuration for the whole network system, such as the items shown in FIG. 12.

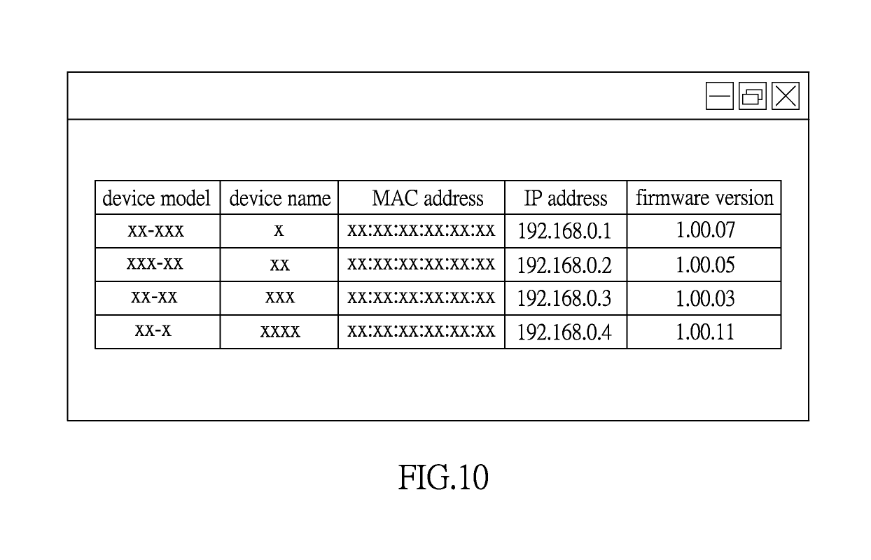

The master 30 is disposed with a second network unit 306 used to connect with the other internal device(s) 32, and a software-implemented network scan unit 305. The network scan unit 305 is used to scan the devices within the local-area network using a broadcast or multicast method in compliance with a specific communication protocol. In the beginning of the operation, the master 30 accepts the instructions for scanning the devices within the network domain made by the operator operating the management interface. The scanning result may be shown in a list on a management interface. The master 30 utilizes a software-implemented device management unit 304 to manage the various types of devices in the local-area network. For example, FIG. 10 shows a list depicting the information by scanning the devices. The device management unit 304 may accordingly introduce a database to arrange an equipment list, and record the device identifications. The device identification information is such as the MAC (Media Access Control) address and the IP address that is set by the operator or allocated by the system. It is noted that the IP address is a factory default value for the devices, or allocated by a DHCP server 202 as shown in FIG. 2. The operator is also allowed to make the setting via the management interface.

It is worth noting that the master 30 may not specify any device in the network but the role of the device designated by the operator using the management serving program. Therefore, the master 30 may be changed to another node when the next management connection is established. The device previously used for the master (30) may be switched to the synchronization-source device, or to the slave for accepting the configuration or firmware.

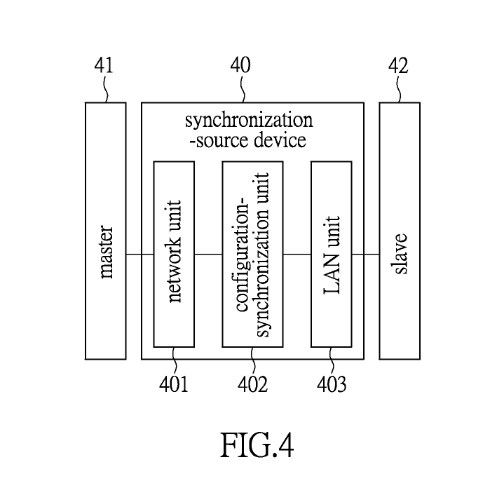

Reference is made to FIG. 4 showing a block diagram depicting the synchronization-source device of the system for managing the multiple devices within a network system.

The example shown in the diagram describes the hardware circuit or software-implemented modules in the device acting as a synchronization-source device 40. A network unit 401 is provided in the device for connecting with a master 41, or other device(s). A LAN unit 403 of the synchronization-source device 40 is incorporated to connecting with the devices such as the slave(s) 42.

The function modules of the device acting as the synchronization-source device 40 include a configuration-synchronization unit 402 which may be a built-in program used for receiving instructions from the master 41. The instructions made by the master 41 are to perform synchronization of the configuration or firmware updating. The configuration-synchronization unit 402 may be a software-implemented function module. The device acting as the synchronization-source device 40 is used for performing intermediate synchronization. In an exemplary example, the operator selects the device as the synchronization-source device 40 from a list resulting in the scanning process made by the master 41. The configuration-synchronization unit 402 is used to share its configuration/firmware including the network function setting, the device function setting, and firmware of the synchronization-source device 40 with another one or more slaves.

FIG. 4 schematically shows the basic functions provided by the synchronization-source device 40. The operator designates a device to share its own configuration/firmware from the master 41. It is noted that the configuration/firmware may be existed in the device (40), or may be completed in a setting procedure. The configuration/firmware may be shared from the device by the previous management procedure. The synchronization-source device 40 may also be qualified as the master when it is able to provide functionalities in compliance with the example shown in FIG. 3.

According to one of the embodiments of the system for managing the multiple devices of the present invention, the operator activates a management interface from the master. The management interface may either be a web page launched by a web browser, the graphic user interface initiated by a program, or a command line using a Telnet command. The management interface is provided for the operator to manage the devices within the network domain. The flow chart shown in FIG. 5 describes the process of the system for managing multiple devices within a network system.

In the procedure of management rendered by the system, such as in the beginning step S501, the operator establishes a connection with the system for managing multiple devices within a network system using a web browser. A network-administration host is provided. The network-administration host may be one of the devices in the network domain, and selected to be a master. One of the requirements qualifying the device as the master is with a web server. A management serving program of the web server is embedded. The management serving program initiates a web-based management interface. Next, in step S503, the operator enters a management web page, such as the step S505. The management serving program generates broadcast packets to scan the network for the acknowledging condition of the devices in the network as receiving the responses made by the devices. In general, the scan program may acquire the MAC addresses of the devices and form a list thereof.

Next, in step S507, the operator may firstly set up the network identification information such as IP addresses for the devices. In one embodiment, the scanning result may be shown in the management interface as shown in the diagram of FIG. 10. The result appears to have the device model, device name, MAC address, IP address, and/or the firmware version for every device. This information may be extracted from the packets responded by the device.

According to the management mechanism rendered by the system for managing multiple devices within a network system, in addition to designating the network-administration host as a master, the remaining devices may be designated by the operator for the purpose of management as the synchronization-source device and slaves. The block diagram for the master may be referred to in the example shown in FIG. 3. A management serving program is embedded in the master. FIG. 4 shows the block diagram implementing the synchronization-source device according to one of the embodiments. A configuration-synchronization unit (402) is introduced to receive the configuration/firmware and performing synchronization with others as demanded. Thus the devices operate well based on the management mechanism of the network system, especially to the synchronization of the configuration/firmware.

Next, in step S509, the operator selects one of the devices to share its configuration/firmware via the management interface. The selected device acts as a master. The master may be the network-administration host mentioned above. A synchronization-source device may also be designated in this step. In step S511, the configuration is such as all or part of the network configurations, and/or firmware updating after selecting the device to conduct the synchronization. Next, all or part of the remaining devices are also selected to be synchronized. After the selection, such as in step S513, the system performs synchronization of the configuration/firmware. Through the local-area network, the configuration/firmware is transferred to the devices selected to be synchronized. The program built in the devices will complete the configuration and/or firmware updating. In one other embodiment, the mentioned configuration/firmware of the synchronization-source device may be firstly transferred to the master, and the master then dispenses the configuration/firmware to the others.

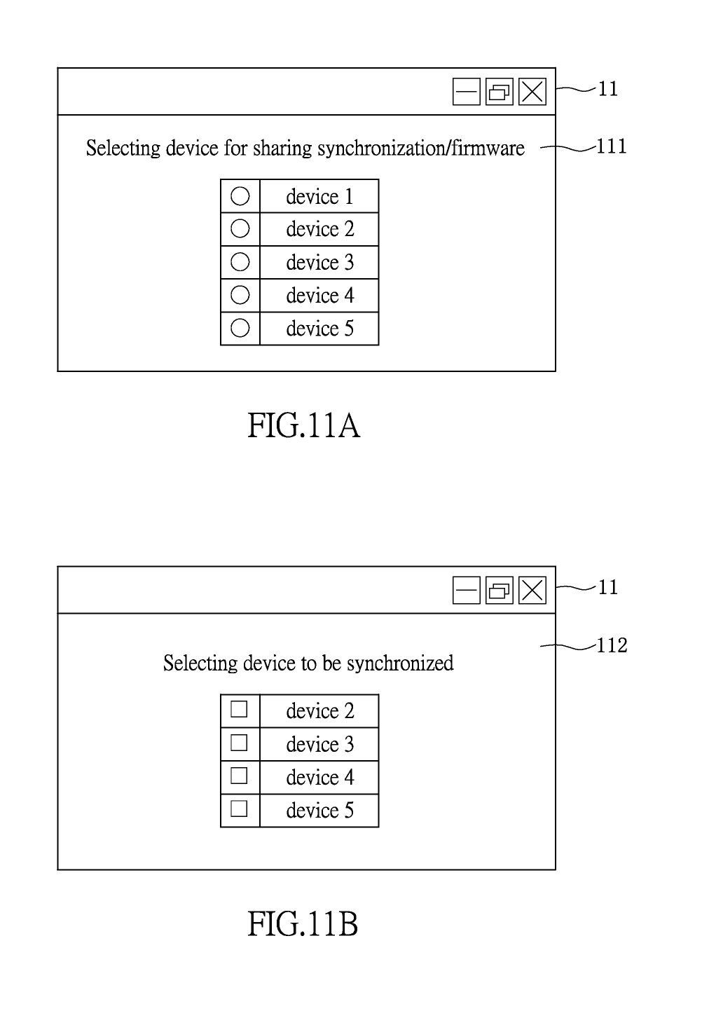

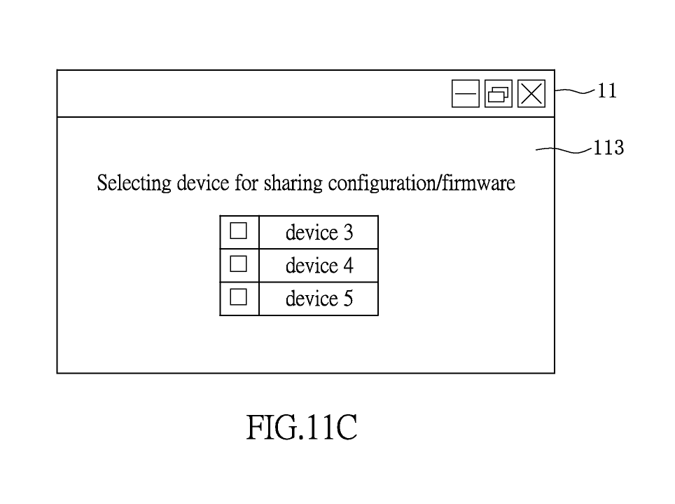

In FIG. 5, the operator selects the device to share its configuration/firmware, and the device(s) to be synchronized via the management interface. The references are made to FIG. 11A through FIG. 11C depicting the management interface made by the system in accordance with the present invention.

FIG. 11A through FIG. 11C schematically show the devices within the network by means of graphic user interface. The devices are such as the device acting as the master, the device acting as the synchronization-source device, and the device(s) being the slaves. It is noted that the roles of devices may be dynamically switched as required.

In FIG. 11A, entering the system for managing multiple devices within a network system, a management serving program in one of the devices is executed to initiate a management interface for listing the information of the scanned devices. For example, the several option items 111 of the “devices selected for sharing configuration/firmware” listed in the window 11. The related devices are such as the device 1 (the present device), the device 2, the device 3, the device 4, and the device 5.

One of the devices is then selected to be the device sharing the configuration/firmware, e.g. the device 1 which may be the present device. The window 11 shown in FIG. 11B has appearing in it the option item 112 of the “devices for synchronizing the configuration/firmware”. The other devices appear rather than the device 1 designated for sharing the configuration/firmware. The other devices are such as the device 2, device 3, device 4, and device 5. These devices are selected to synchronize the configuration/firmware, and act as the slaves under the management mechanism.

Rather than device 1, if device 2 is selected to be the device for sharing the configuration/firmware in the option item 111 shown in FIG. 11A, as shown in FIG. 11 C appearing in the option item 113 of the “device for synchronizing the configuration/firmware” are device 3, device 4, and device 5 excepting device 1 and device 2. Theses devices are acting as the slaves selected to synchronize the configuration/firmware.

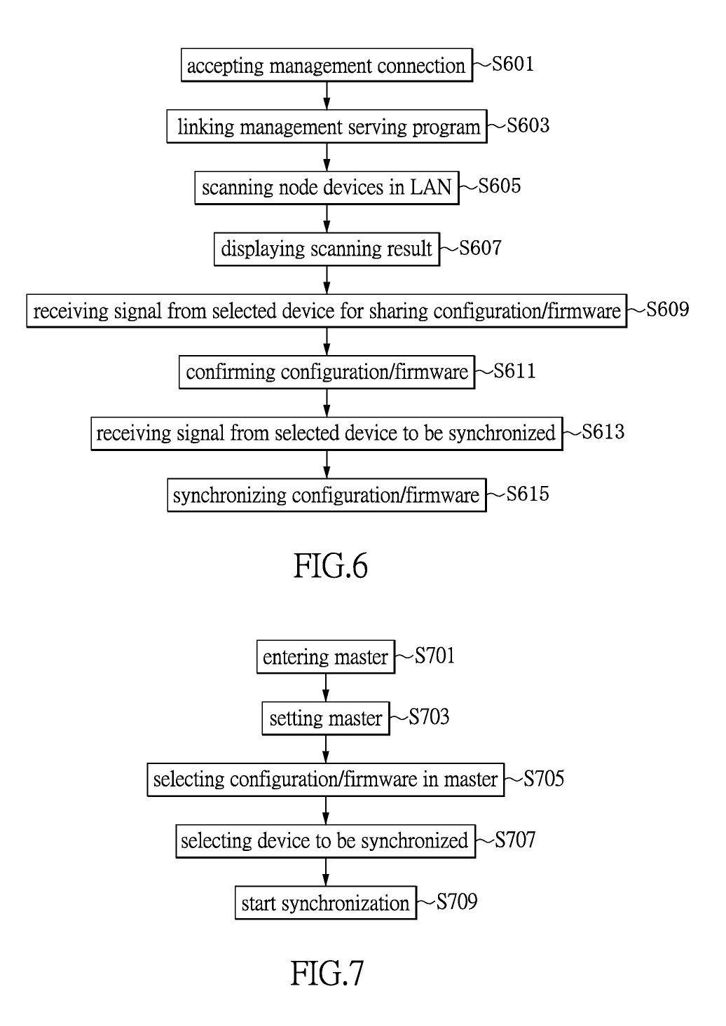

Reference is made to FIG. 6 showing a flow chart illustrating the method for managing the multiple devices within a network system in one embodiment.

When the system has completed the activation and initialization, in the beginning such as step S601, the system may receive a request for management connection. Next, in step S603, the system links a management serving program for receiving the management connection. A user identification procedure is also activated for identifying the operator. According to the further instructions, or by the automatic process, the system scans the devices within the network domain, such as in step S605. The management serving program may include a web server for initiating a web-based management interface.

After that, in step S607, a scanning result is displayed in the management interface. The management interface may also show the previous scanning result if there is not any change. Thus the list shows the information based on the scanning result.

Next, such as in step S609, the list having the scanning result is provided for the master to acknowledge any device selected for sharing the configuration/firmware. The selected node may be the master itself, or the synchronization-source device. In step S611, the master may confirm the configuration/firmware to be synchronized. The configuration/firmware is such as the network function setting, the device function setting, and/or the updating firmware. The configuration/firmware is configured to apply to other devices, in which, a list may be provided for the operator to make a selection for conducting the synchronization. The system receives the signal of selecting device-to-be-synchronized, such as in step S613. The synchronization is performed to apply the configuration/firmware from the selected device to the other devices, such as in step S615.

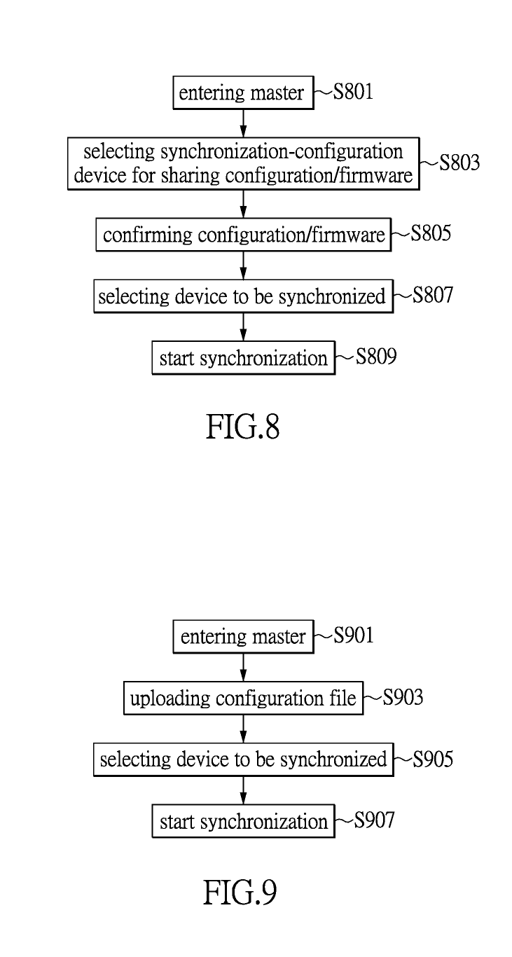

The master may have the hardware or software-implemented modules for receiving the setting, sharing the configuration/firmware, and initiating the management interface. The related embodiment is shown in FIG. 3. The synchronization-source device is embedded with hardware or software-implemented modules for sharing its own configuration/firmware, as shown in FIG. 4. When the selection is made, the configuration/firmware is applied to the selected devices for performing the synchronization. FIG. 7 and FIG. 8 respectively describe the examples of the device designated to be the master for sharing the configuration/firmware, and the device selected to be the synchronization-source device using the management interface provided by the master.

FIG. 7 shows the flow chart describing configuring the master.

When the operator accesses the master, such as step S701, the master may authenticate the operator and decide whether or not to accept the request. A verifying procedure may be performed, for example, but not limited to, requiring keying in the account and password, conducting chip identification, or other verification. This is supposed to authenticate the connection.

In step S703, via the management interface, the master is set. In step S705, the master is selected to be the device for sharing the configuration/firmware. In step S707, the other one or more devices are selected to be synchronized. After that, in step S709, the configuration/firmware is synchronized with the devices via a specific channel or network. The devices then perform the configuration by their internal programs.

FIG. 8 shows a flow chart illustrating selecting the device to be a synchronization-source device.

In step S801, the operator enters the master, and activates a management interface. It is able to make a selection of a device for synchronization, and scan the devices, e.g. the slaves, within the network system. One of the devices is selected to be the device for sharing the configuration/firmware. The device acts as the synchronization-source device, such as step S803. The other device-to-be-synchronized may act as the one or more slaves.

In the meantime, such as step S805, the master confirms the configuration/firmware in the synchronization-source device through the instructions or tools via the management interface. The configuration/firmware is such as the network function setting, the device function setting, and/or firmware. Then the device(s) to be synchronized is selected, such as step S807. The configuration/firmware is then synchronized after the setting, such as step S809.

It is worth noting that when the operator selects the device to be the master or the synchronization-source device for sharing the configuration/firmware, the management interface may also provide some options. The configuration/firmware is such as the network function setting, and can be understood by the skilled person in the art. The configuration/firmware may be as the setting items shown in FIG. 12. The setting items may be adapted to all the devices in the network system, but may be applicable to part of them. The system may exclude the incompatible device(s) which may be selected to conduct the synchronization for preventing any error in the synchronization process. For example, the model or firmware version for the device may be used to judge whether or not it is applicable to the synchronization. This is related to the mechanism of debugging and fault tolerance.

FIG. 9 shows another flow chart illustrating another method for synchronizing the configuration/firmware. In the method, no device having the configuration/firmware is selected, but a configuration file is uploaded to the master for sharing.

In step S901, the operator is required to enter the master, and upload a configuration file via the management interface. In step S903, and the step S905, one or more devices are also selected to be synchronized. The uploaded configuration file is then synchronized with the selected devices. In step S907, the synchronization starts.

FIG. 12 schematically shows a web page depicting the master directly sharing its configuration/firmware with others in the method for managing multiple devices within a network system. The method is also applicable to the selected synchronization-source device, and the slave(s).

Firstly, a web-based graphic user interface is provided for the operator to operate. The left field shows, but is not limited to, the samples of the configuration/firmware.

In the example, the management interface initiates some options for the operator to make the selection. A master or synchronization-source device for sharing the configuration/firmware is firstly selected. There are several conventional setting items 121 shown in the left field, such as SNMP (Simple Network Management Protocol), L2 Table, Age Time, RSTP (Rapid Spanning Tree Protocol)/MSTP (Multiple Spanning Tree Protocol), RSTP Time Intervals, MSTP Instance Mapping, IGMP Snooping (Internet Group Management Protocol snooping), IGMP Time Intervals, QoS (Quality of Service), CoS Mapping (Class of Service), Queue Weight, and Algorithm.

When the operation finishes the above or other settings, the devices to be synchronized can be selected. The items at the right sidebar shown in the diagram allow the operator to select the device-to-be-synchronized 123. For example, the hostname or identifier for the every device-to-be-synchronized 123 is shown in a list, including the first slave, the second slave, etc. Then the further step of synchronization is performed.

It is noted that the system is able to exclude the incompatible devices which are not applied with the configuration/firmware according to the models of the devices or/and the firmware versions when operating the synchronization. This approach may prevent the error synchronization.

To sum up, the system and method for managing the multiple devices within a network system render a management mechanism for the system having multiple devices and various equipment. Especially to the configuration/firmware including the network configuration for the network system, or/and the updating firmware, the several roles for the devices within the system are used to conduct the synchronization. For example, the master is dynamically designated for the purpose of management and setting; the synchronization-source device is designated for intermediate synchronization of the configuration/firmware; and the slave is as the terminal device. The system renders a mechanism for effectively synchronizing the configuration/firmware. The network system may be updated rapidly.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A method for managing multiple devices over a network, comprising:
accepting a management connection, linking a management serving program of a device, and initiating a management interface;
through the management interface, listing information of multiple devices within a network domain;
through the management interface, receiving a signal designating the device or another device to share a configuration/firmware;
through the management interface, receiving a signal selecting one or more devices for synchronizing the configuration/firmware;
wherein the one or more devices for synchronizing the configuration/firmware are different from the device or the another device sharing the configuration/firmware; and
applying the configuration/firmware to the selected one or more devices for synchronizing the configuration/firmware, comprising:
the configuration/firmware is applied to the selected one or more devices when designating the device to synchronize the configuration/firmware through the management interface; and
the configuration/firmware is applied to the selected one or more devices when designating the another device to synchronize the configuration/firmware through the management interface.

2. The method of claim 1, wherein the configuration/firmware is network function setting, device function setting, and/or updating firmware.

3. The method of claim 1, wherein the management serving program performs a user identification procedure as accepting the management connection, and starts scanning the devices within the network domain.

4. The method of claim 3, wherein the configuration/firmware is network function setting, device function setting, and/or updating firmware.

5. The method of claim 3, wherein the management serving program includes a web server used to provide the management interface.

6. The method of claim 5, wherein the configuration/firmware is network function setting, device function setting, and/or updating firmware.

7. The method of claim 6, wherein, when applying the configuration/firmware to the selected one or more devices, the incompatible device-to-be-synchronized is excluded according to every device's model or version of firmware.

8. The method of claim 7, wherein the device accepting the management connection operates as a master; the another device designated to share the configuration/firmware operates as a synchronization-source device; the device receiving the configuration/firmware operates as a slave.

9. A system for managing multiple devices within a network system, comprising:
multiple interconnected devices, within a local-area network, comprising:
a device designated to be a master, having a first network unit rendering a management connection for entering and configuring the system for managing multiple devices, and a second network unit connecting with the local-area network; wherein the master provides a management interface to configure the master, or to configure other device, so as to synchronize configuration/firmware with other network nodes within the local-area network;
wherein, when one device is selected by the master through the management interface for sharing the configuration/firmware, the configuration/firmware is applied to the other slaves to be synchronized, comprising:
through the management interface, the master is designated to synchronize the configuration/firmware with the selected devices-to-be-synchronized, which act as the slaves; and
through the management interface, another one device is designated to conduct intermediate synchronization for applying the configuration/firmware with the other selected devices, which act as the slaves.

10. The system of claim 9, wherein, the device operating as the master has a web server used to provide the web-based management interface.

11. The system of claim 9, wherein the device operates as the master which is disposed with a network scan unit used to scan the devices within the local-area network.

12. The system of claim 9, wherein the one of the devices of the system for managing multiple devices is designated as the master through the management connection; and the another device is designated as a synchronization-source device for sharing a configuration/firmware through the management interface; rather than the master and the synchronization-source device, the remaining one or more devices in the system for managing multiple devices act as the slave receiving the configuration/firmware.
